(19) United States
(12) Patent Application Publication
(10) Pub. No.: US 2025/0385318 A1
(43) Pub. Date: Dec. 18, 2025

(54) SECONDARY PRISMATIC BATTERY CELL

(71) Applicant: GM GLOBAL TECHNOLOGY OPERATIONS LLC, Detroit, MI (US)

(72) Inventor: Seung-Woo Chu, Sterling Heights, MI (US)

(73) Assignee: GM GLOBAL TECHNOLOGY OPERATIONS LLC, Detroit, MI (US)

(21) Appl. No.: 18/743,358

(22) Filed: Jun. 14, 2024

(51) Int. Cl. H01M 10/0583; H01M 4/02; H01M 4/131; H01M 4/525; H01M 4/583; H01M 4/62; H01M 10/42; H01M 50/46; H01M 50/538

(52) U.S. Cl. CPC H01M 10/0583; H01M 4/131; H01M 4/525; H01M 4/583; H01M 4/625; H01M 50/46; H01M 50/538; H01M 2004/021; H01M 2004/027; H01M 2004/028; H01M 2010/4292; H01M 2220/20

(57) ABSTRACT

A secondary battery cell includes a battery cell enclosure, an electrolyte, and an electrode assembly. The electrode assembly includes a cathode with a cathode area, an anode, a separator (i) with an anode-facing side and a cathode-facing side, (ii) with a bonding area on the cathode-facing side and completely outside the cathode area, and (iii) configured to physically separate the cathode and the anode, and an adhesive strip applied solely on the cathode-facing side of the separator. The cathode is either partially enclosed or completely enclosed by the separator. The adhesive strip is completely in the bonding area. Two segments of the adhesive strip on opposing sides of the cathode are bonded to each other.

### INTRODUCTION

The present disclosure relates to a structure and a method for manufacturing a secondary prismatic battery cell.

Lithium ion battery cells describe a class of rechargeable battery cells in which lithium ions move between a negative electrode (i.e., anode) and a positive electrode (i.e., cathode). Liquid and polymer electrolytes can facilitate the movement of lithium ions between the anode and the cathode. Lithium-ion battery cells are growing in popularity for automotive and aerospace applications due to increasing energy storage densities and an ability to undergo successive charge and discharge cycles.

Accordingly, those skilled in the art continue with research and development efforts in the field of secondary prismatic battery cell designs to improve the energy storage density.

### SUMMARY

A secondary battery cell is provided herein. The secondary battery cell includes a battery cell enclosure, an electrolyte disposed in the battery cell enclosure, and an electrode assembly disposed in the battery cell enclosure. The electrode assembly includes a cathode with a cathode area, an anode, a separator (i) with an anode-facing side and a cathode-facing side, (ii) with a bonding area on the cathode-facing side and completely outside the cathode area, and (iii) configured to physically separate the cathode and the anode, and an adhesive strip applied solely on the cathode-facing side of the separator. The cathode is either partially enclosed or completely enclosed by the separator. The adhesive strip resides completely in the bonding area. Two segments of the adhesive strip on opposing sides of the cathode are bonded to each other.

In one or more embodiments of the secondary battery cell, the separator is in direct physical contact with the anode and the cathode.

In one or more embodiments of the secondary battery cell, the battery cell enclosure is a prismatic metal enclosure. A pair of electrical terminals are attached in a common plane along a side of the prismatic metal enclosure. The pair of electrical terminals have a terminal height. An enclosure height of the prismatic metal enclosure is between approximately 100 millimeters and approximately 110 millimeters, excluding the terminal height of the pair of electrical terminals. An enclosure width of the prismatic metal enclosure is between approximately 250 millimeters and approximately 300 millimeters.

In one or more embodiments of the secondary battery cell, a ratio between a cathode height of the cathode and the enclosure height of the prismatic metal enclosure is greater than 0.874 to 1.

In one or more embodiments of the secondary battery cell, the cathode, the anode, and the separator are arranged in a Z-folded stack. A plurality of tabs are (i) connected to the cathode and the anode and (ii) arranged in a plane parallel with a location of the pair of electrical terminals.

In one or more embodiments of the secondary battery cell, the secondary battery cell has a nominal voltage between approximately 3.63 volts and approximately 3.66 volts while energy is measured between a maximum voltage and a minim voltage of the secondary battery cell. The cathode has an aerial specific capacity loading between approximately 4.95 milliampere hours per centimeter squared and approximately 5.4 milliampere hours per centimeter squared. A specific capacity of cathode active material in the cathode has at least approximately 195 milliampere hours per gram when measured at a 1/10 Celsius rate at 25 degrees Celsius. A current collector thickness of the cathode is between approximately 10 micrometers and approximately 14 micrometers. An anode active material of the anode includes graphite and silicon oxide. The silicon oxide in the anode is less than 6 percent in weight ratio.

In one or more embodiments of the secondary battery cell, the cathode and the anode contain a plurality of carbon nano tubes. The plurality of carbon nano tubes do not exceed at least one of (i) 0.2 percent weight for the anode and (ii) 1.2 percent weight for the cathode.

In one or more embodiments of the secondary battery cell, the secondary battery cell has a nominal voltage between approximately 3.67 volts to approximately 3.71 volts while energy is measured between a maximum voltage and a minimum voltage of the secondary battery cell. A cathode has an aerial specific capacity loading between approximately 4.95 milliampere hours per centimeter squared and approximately 5.4 milliampere hours per centimeter squared. A specific capacity of a cathode material in the cathode has at least approximately 195 milliampere hours per gram when measured at 1/10 Celsius rate at 25 degrees Celsius. An anode active material of the anode is graphite.

In one or more embodiments of the secondary battery cell, the electrode assembly contains between at least 70 sheets and a maximum of 85 sheets of the cathode.

In one or more embodiments of the secondary battery cell, a bonding area width of the bonding area in the separator is less than approximately 2 millimeters.

A method for manufacturing a secondary battery cell is provided herein. The method includes applying an adhesive strip solely on a cathode-facing side of a separator. The separator (i) has an anode-facing side and the cathode-facing side, (ii) has a bonding area on the cathode-facing side that is completely outside a cathode area of a plurality of cathodes, and (iii) is configured to physically separate the plurality of cathodes and a plurality of anodes. The plurality of cathodes is either partially enclosed or completely enclosed by the separator. The adhesive strip resides completely in the bonding area. The method further includes placing the separator on a base plate, placing a first anode of the plurality of anodes on the separator, folding the separator over the first anode, placing a first cathode of the plurality of cathodes on the separator opposite the first anode, folding the separator over the first cathode, applying a force to the separator in the bonding area to bond two segments of the adhesive strip on opposite sides of the first cathode to each other, placing a second anode of the plurality of anodes on the separator opposite the first cathode, folding the separator over the second anode, placing a second cathode of the plurality of cathodes on the separator opposite the second anode, applying the force to the separator in the bonding area to bond two additional segments of the adhesive strip on opposite sides of the second cathode to each other, wrapping the plurality of cathodes and the plurality of anodes with the separator to form an electrode assembly, disposing the electrode assembly in a battery cell enclosure, and disposing an electrolyte in the battery cell enclosure.

In one or more embodiments of the method, the separator is in direct physical contact with the plurality of anodes and the plurality of cathodes.

In one or more embodiments of the method, the plurality of cathodes, the plurality of anodes, and the separator are arranged in a Z-folded stack.

In one or more embodiments of the method, the battery cell enclosure is a prismatic metal enclosure.

In one or more embodiments, the method includes attaching a pair of electrical terminals in a common plane along a side of the prismatic metal enclosure. The pair of electrical terminals have a terminal height.

In one or more embodiments, the method includes connecting the plurality of cathodes and the plurality of anodes to the pair of electrical terminals.

In one or more embodiments of the method, an enclosure height of the prismatic metal enclosure is between approximately 100 millimeters and approximately 110 millimeters, excluding the terminal height of the pair of electrical terminals. An enclosure width of the prismatic metal enclosure is between approximately 250 millimeters and approximately 300 millimeters.

In one or more embodiments of the method, a ratio between a cathode height of the plurality of cathodes and the enclosure height of the prismatic metal enclosure is greater than 0.874 to 1.

In one or more embodiments of the method, the electrode assembly contains between at least 70 sheets and a maximum of 85 sheets of the plurality of cathodes.

A vehicle is provided herein. The vehicle includes a battery pack with a plurality of secondary battery cells. At least one of the secondary battery cells includes a battery cell enclosure, an electrolyte disposed in the battery cell enclosure, and an electrode assembly disposed in the battery cell enclosure. The electrode assembly includes a cathode with a cathode area, an anode, a separator (i) with an anode-facing side and a cathode-facing side, (ii) with a bonding area on the cathode-facing side and completely outside the cathode area, and (iii) configured to physically separate the cathode and the anode, and an adhesive strip applied solely on the cathode-facing side of the separator. The cathode is either partially enclosed or completely enclosed by the separator. The adhesive strip resides completely in the bonding area. Two segments of the adhesive strip on opposite sides of the cathode are bonded to each other.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic plan diagram illustrating a context of a system.

FIG. 2 is a schematic cross-sectional diagram of a secondary prismatic battery cell in accordance with one or more exemplary embodiments.

FIG. 3 is a schematic cross-sectional diagram of a sequence of cathode transformation during manufacturing in accordance with one or more exemplary embodiments.

FIG. 4 is a schematic perspective diagram of a process of assembling a secondary battery cell in accordance with one or more exemplary embodiments.

FIG. 5 is a schematic cross-sectional diagram of a processing method in accordance with one or more exemplary embodiments.

FIG. 6 is a schematic side view diagram of an electrode assembly in accordance with one or more exemplary embodiments.

FIG. 7 is another schematic side view diagram of the electrode assembly in accordance with one or more exemplary embodiments.

FIG. 8 is a schematic perspective diagram of an unfolded electrode assembly in accordance with one or more exemplary embodiments.

FIG. 9 is a flow diagram of a method for manufacturing a secondary battery cell in accordance with one or more exemplary embodiments.

### DETAILED DESCRIPTION

Embodiments of the disclosure generally provide a secondary prismatic battery cell with an increased energy density relative to existing prismatic battery cells. A battery cell assembly in the secondary prismatic battery cell increases an electrode size inside of a protective (e.g., metallic) prismatic enclosure. The increased size of the electrode may be achieved by reducing an overhang dimension of a separator between neighboring electrodes. An adhesive layer on overhang locations of the separator, with the electrodes assembled, and a subsequent bonding process of layers formed by the separator after an electrode assembly process has completed, generally enables the reduction of the separator overhang in the battery electrode assembly. The bonded layers of the separator generally improves a robustness for shorting issues due to plating and bridging over the separator, when the separator is folded or torn due to manufacturing process issues.

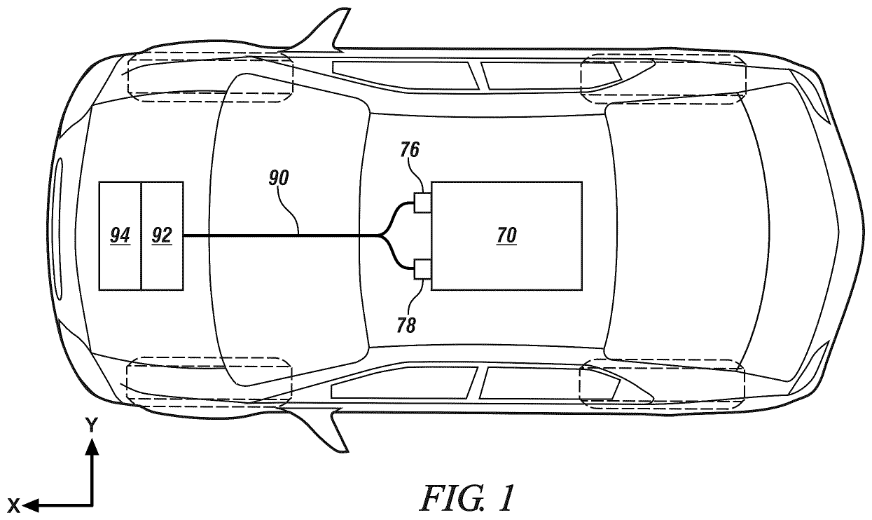

Referring to FIG. 1, a schematic plan diagram illustrating a context of a system is shown. The system may implement a vehicle 60. The vehicle 60 generally comprises a battery pack 70, a harness 90, a controller 92 and a motor 94. The battery pack 70 may include a positive battery pack terminal 76 and a negative battery pack terminal 78. For the purposes of explanation, a front of the vehicle 60 may be aligned in a positive X direction. A right side of the vehicle 60 (as seen looking down at a top of the vehicle 60) may be aligned in a positive Y direction. The positive Y direction may be perpendicular to the positive X direction.

The vehicle 60 may include, but is not limited to, mobile objects such as a passenger vehicle, a truck, an autonomous vehicle, a gas-powered vehicle, an electric-powered vehicle, a hybrid vehicle, a motorcycle, a boat, a farm vehicle, a train and/or an aircraft. In some embodiments, the vehicle 60 may include stationary objects such as billboards, kiosks and/or marquees. Other types of vehicles 60 may be implemented to meet the design criteria of a particular application.

The battery pack 70 may implement a high-voltage battery pack configured to store electrical energy. The battery pack 70 is generally operational to receive electrical power from the controller 92 and provide electrical power to the controller 92. The battery pack 70 may include multiple battery modules electrically connected in series and/or in parallel between the positive battery pack terminal 76 and the negative battery pack terminal 78. In various embodiments, the battery pack 70 may provide approximately 400 to 800 volts DC (direct current) electrical potential between the positive battery pack terminal 76 and the negative battery pack terminal 78. Other battery voltages may be implemented to meet the design criteria of a particular application. The positive battery pack terminal 76 and the negative battery pack terminal 78 may be physically and electrically connected to the harness 90.

The harness 90 may implement an electrical harness. The harness 90 is generally operational to carry electrical power between the controller 92 and the battery pack 70. In a charging mode, the harness 90 may transfer the electrical power from the controller 92 to the battery pack 70. In a discharging mode, the electrical power may flow along the harness 90 from the battery pack 70 to the controller 92.

The controller 92 may implement a battery controller. The controller 92 is generally operational to transfer electrical power to the battery pack 70 in the charging mode to charge the battery pack 70 The controller 92 may draw electrical power from the battery pack 70 in the discharge mode. The electrical power received from the battery pack 70 may be used to power the motor 94 and/or other loads within the vehicle 60.

The motor 94 may implement an electric motor. The motor 94 is generally operational to provide rotation and torque to drive wheels of the vehicle 60. The electrical power consumed by the motor 94 may be provided by the battery pack 70 and/or an alternator of the vehicle 60 under the control of the controller 92.

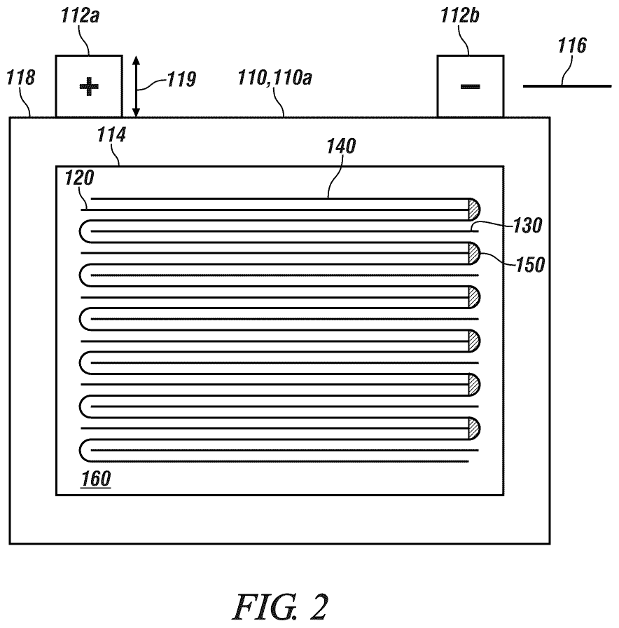

Referring to FIG. 2, a schematic cross-sectional diagram of an example implementation of a secondary prismatic battery cell 100 is shown in accordance with one or more exemplary embodiments. Multiple secondary prismatic battery cells 100 may reside in the battery pack 70 to receive electrical power, store electrical energy, and provide electrical power to the vehicle 60. In various embodiments, the secondary prismatic battery cell 100 includes a battery cell enclosure 110, multiple (e.g., two) electrical terminals 112a-112b, and an electrode assembly 114. The electrode assembly 114 generally includes one or more cathodes 120, one or more anodes 130, a separator 140, and an adhesive strip 150.

The battery cell enclosure 110 implements a sealed housing. The battery cell enclosure 110 is arranged to house the cathodes 120, the anodes 130, the separator 140 and the adhesive strip 150. In various embodiments, the battery cell enclosure 110 may be a prismatic metal enclosure 110a. An enclosure height of the battery cell enclosure 110/prismatic metal enclosure 110a may range between approximately 100 millimeters (mm) and approximately 110 mm (e.g., 103 mm), excluding the terminal height of the pair of electrical terminals 112a-112b. An enclosure width of the battery cell enclosure 110/prismatic metal enclosure 110a is between approximately 250 mm and approximately 300 mm (e.g., 260 mm). An enclosure width of the battery cell enclosure 110/prismatic metal enclosure 110a is between approximately 25 mm and approximately 36 mm.

The electrical terminals 112a-112b implement a pair of battery terminals. The electrical terminals 112a-112b are operational as a positive terminal and a negative terminal. The electrical terminals 112a-112b are attached in a common plane 116 along a side 118 (e.g., a top side as viewed in the figure) of the battery cell enclosure 110. The pair of electrical terminals 112a-112b have a terminal height 119.

The electrode assembly 114 implements a logical collection of the cathodes 120, the anodes 130, the separator 140, and the adhesive strip 150. The electrode assembly 114 generally provides mechanical support for the cathodes 120, the anodes 130, the separator 140, and the adhesive strip 150. The electrode assembly 114 is operational to contain an electrolyte 160. The electrode assembly 114 may contain between at least 70 sheets and a maximum of 85 sheets of cathodes and a similar number of anodes.

In various embodiments, the electrode assembly 114 may formed in part or in total by the battery cell enclosure 110.

The cathodes 120 implement portions of electrochemical cells. Ions may move from anodes 130 to the cathodes 120 while the secondary prismatic battery cell 100 is discharging. The cathodes 120 have a generally rectangular shape that defines a cathode area.

The anodes 130 implement opposite portions of the electrochemical cells. Ions may move from the cathodes 120 to the anodes 130 while the secondary prismatic battery cell 100 is charging. The anodes 130 have a generally rectangular shape that defines an anode area. The anode area may be different than, or the same as the cathode area.

The separator 140 implements a ion-permeable membrane. The separator 140 is configured to physically separate the cathodes 120 and the anodes 130. The separator 140 is operational to conduct ions during charging and discharging, and optionally conduct molecules of the electrolyte 160 (e.g., a liquid electrolyte). In various embodiments, the separator 140 has an anode-facing side that faces the anodes 130, and a cathode-facing side that faces the cathodes 120. A bonding area is defined solely on the cathode-facing side of the separator 140. The bonding area is completely outside the cathode area while the separator 140 is aligned with the cathodes 120 and the anodes 130. The bonding area is generally an area where the separator 140 overhangs cathode material and/or anode material.

The adhesive strip 150 implements a layer or coating on one side of the separator 140. The adhesive strip 150 has adhesive mixture that enables bonding to the separator 140 and to itself. In various embodiments, the adhesive strip 150 may be a continuous strip, a discontinuous strip, or combinations thereof.

The electrolyte 160 implements an electric conductor in which current is carried between the cathodes 120 and the anodes 130 by the movement of the ions. In various embodiments, the electrolyte 160 is a liquid electrolyte.

In various embodiments, the secondary prismatic battery cell 100 has a nominal voltage between approximately 3.63 volts and approximately 3.66 volts while energy is measured between a maximum voltage and a minim voltage of the secondary prismatic battery cell 100. The cathodes 120 have an aerial specific capacity loading between approximately 4.95 milliampere hours per centimeter squared (mAh/cm²) and approximately 5.4 mAh/cm². A specific capacity of cathode active material in the cathodes 120 has at least approximately 195 milliampere hours per gram (mAh/g) when measured at a 1/10 Celsius rate at 25 degrees Celsius. An anode active material of the anodes 130 includes graphite and silicon oxide. The silicon oxide in the anodes 130 is less generally than 6 percent in weight ratio. The areal specific capacity refers to an amount of charge that may be stored per unit area of the electrode. The specific capacity refers to an amount of charge that may be stored per unit mass of the electrode.

In some embodiments, the secondary prismatic battery cell 100 has a nominal voltage between approximately 3.67 volts to approximately 3.71 volts while energy is measured between a maximum voltage and a minimum voltage of the secondary prismatic battery cell 100. The cathode electrode has an aerial specific capacity loading between approximately 4.95 milliampere hours per centimeter squared and approximately 5.4 mAh/cm2. A specific capacity of a cathode material in the cathodes 120 has at least approximately 195 mAh/g when measured at 1/10 Celsius rate at 25 degrees Celsius. The anode active material of the anodes 130 may be graphite.

In other embodiments, the cathodes 120 and/or the anodes 130 may contain a multiple carbon nano tubes. The carbon nano tubes do not exceed at least one of (i) 0.2 percent weight for the anodes 130 and (ii) 1.2 percent weight for the cathodes 120.

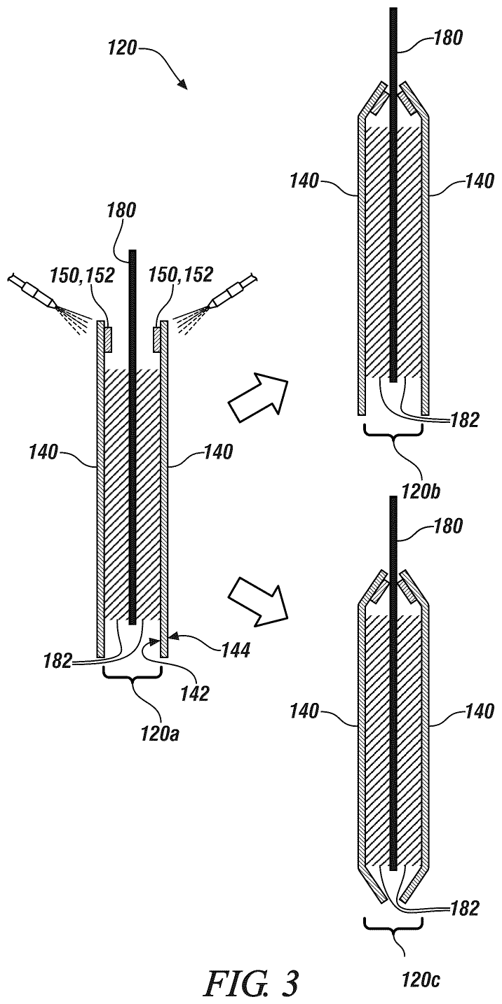

Referring to FIG. 3, a schematic cross-sectional diagram of an example sequence of cathode transformation during manufacturing is shown in accordance with one or more exemplary embodiments. The cathode 120 is illustrated as a cathode 120a before manufacturing. A cathode 120b is illustrated after manufacturing with the cathode 120b partially enclosed by the separator 140. A cathode 120c is illustrated after manufacturing with the cathode 120c fully enclosed by the separator 140. The cathodes 120, 120a and 120b generally include a current collector 180 and multiple (e.g., two) blocks of cathode materials 182.

The current collector 180 implements a conductive metal film (or plate). The current collector 180 is operational to transfer electrons between a positive electrical terminal 112a of the secondary prismatic battery cell 100 and the cathode materials 182. The current collector 180 is disposed between, is in direct physical contact with, and is in direct electrical contact with the two cathode materials 182. A current collector thickness of the current collector 180 of the cathode 120 is between approximately 10 micrometers and approximately 14 micrometers.

The cathode material 182 implements an active cathode material. The cathode material 182 is operational to undergo intercalation and deintercalation while functioning as the positive terminal of the electrode assembly 114.

Prior to manufacturing (or assembling) of the secondary prismatic battery cell 100, the separator 140 may be oriented parallel to the current collector 180 of the cathode 120a. The two segments 152 of the adhesive strip 150 are physically separated from each other and the current collector 180. The two segments 152 are attached to the cathode-facing side 142 of the separator 140.

After manufacturing in various embodiments, of the secondary prismatic battery cell 100, the separator 140 may be bent (or curved) toward the current collector 180 of the cathode 120b. The two segments 152 of the adhesive strip 150 physically touch and bond to each other and the current collector 180. At the opposite end of the cathode 120b, ends of the separator 140 remain apart leaving the cathode 120b partially enclosed by the separator 140.

After manufacturing in other embodiments, of the secondary prismatic battery cell 100, the separator 140 may be bent (or curved) toward the current collector 180 of the cathode 120c. The two segments 152 of the adhesive strip 150 physically touch and bond to each other and the current collector 180. At the opposite end of the cathode 120c, the ends of the separator 140 are pressed together leaving the cathode 120c fully enclosed by the separator 140.

The anodes 130 have the same general structure as the cathodes 120 with a few differences. Instead of the cathode material 182 on either side of the current collector 180, the anodes 130 may have anode material on either side of the current collector 180. The current collector 180 of an anode 130 is operational to transfer electrons between a negative electrical terminal 112b of the secondary prismatic battery cell 100 and the anode materials. Furthermore, the adhesive strip 150 is absent from the anode-facing side 144 of the separator 140.

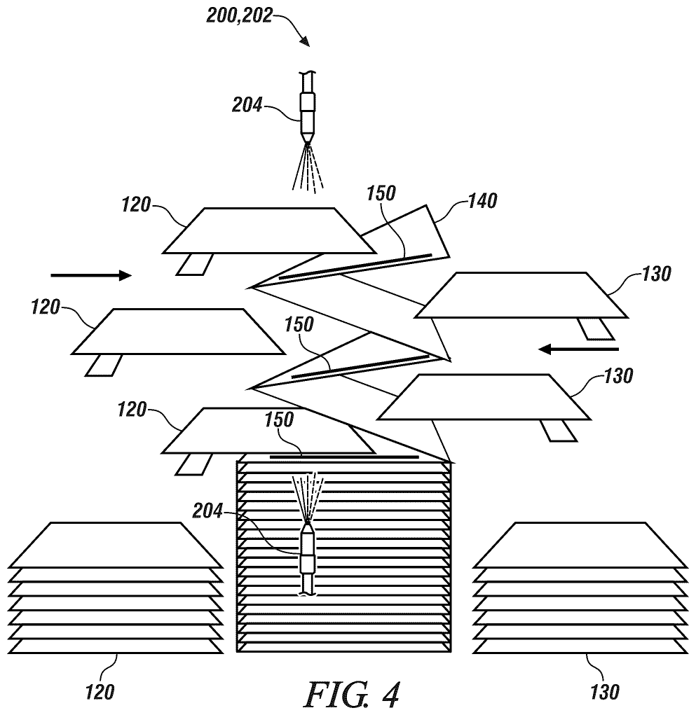

Referring to FIG. 4, a schematic perspective diagram of an example process 200 of assembling a secondary prismatic battery cell 100 is shown in accordance with one or more exemplary embodiments. The process 200 generally involves interleaving the cathodes 120 and the anodes 130 with each other in layers while folding the separator 140 between the layers. The interleaving may be a Z-folded stack technique 202. One or more pneumatic guns 204, or similar devices, may be used to apply a pneumatic force or a mechanical force that compress an edge of the separator 140 to bond the adhesive strip 150 to itself and enclose the cathodes 120 and the anodes 130.

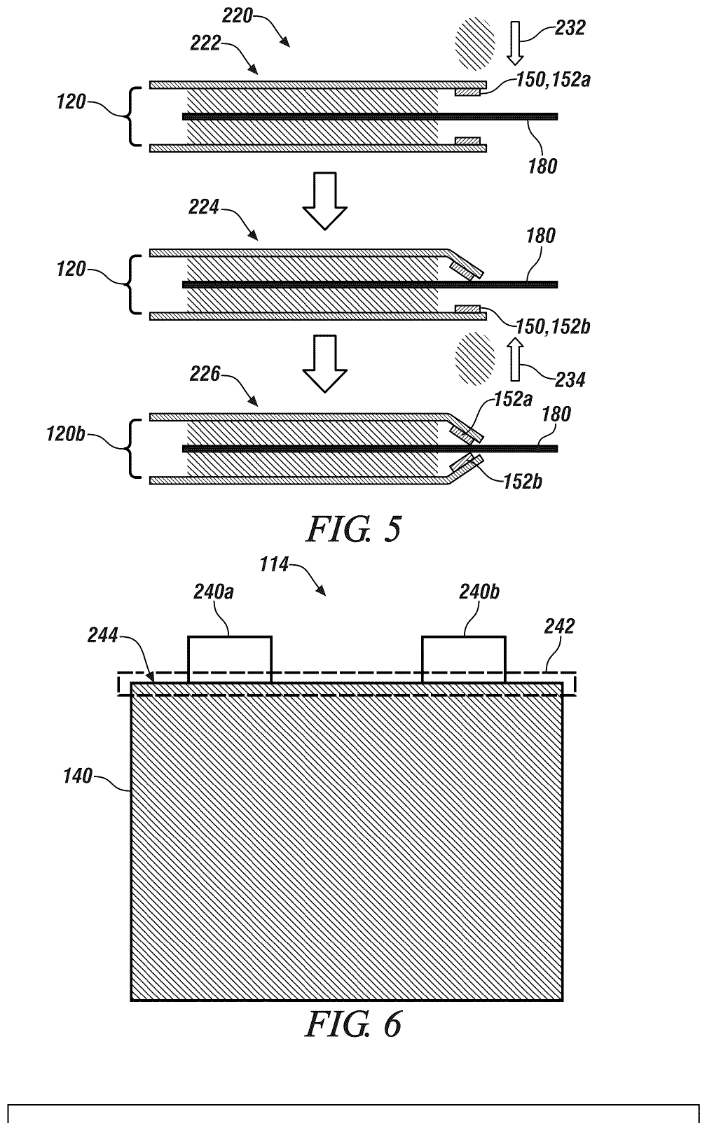

Referring to FIG. 5, a schematic cross-sectional diagram of an example processing method 220 involving a cathode 120 is shown in accordance with one or more exemplary embodiments. The method (or process) 220 generally includes steps 222 to 226, as illustrated. The sequence of steps is shown as a representative example. Other step orders may be implemented to meet the criteria of a particular application.

In the step 222, a first force 232 may be applied to one side (e.g., a top side as illustrated) of the separator 140 at a first segment 152a of the adhesive strip 150. The first force 232 generally bends the separator 140 such that the first segment 152a of the adhesive strip 150 bonds to the current collector 180.

In the step 224, the first force 232 is removed and a second force 234 may be applied to the opposite side (e.g., a bottom side as illustrated) of the separator 140 at a second segment 152b of the adhesive strip 150. The second force 234 generally bends the separator 140 such that the second segment 152b of the adhesive strip 150 bonds to the current collector 180 and to the first segment 152a. In the step 226, the second force 234 is removed. The resulting cathode 120b (see FIG. 3) may be partially enclosed. In various embodiments, the forces 232 and 234 may be applied in other orders or simultaneously.

Referring to FIG. 6, a schematic side view diagram of an example electrode assembly 114 is shown in accordance with one or more exemplary embodiments. The electrode assembly 114 may include a pair of tabs 240a-240b. An area for bonding 242 in the separator 140 generally aligns along a tab side 244 of the electrode assembly 114. The tab side 244 is the same side that contains the pair of tabs 240a-240b. In various embodiments, the tabs 240a-240b are formed from the current collectors 180 (FIG. 5) of the cathodes 120 and the anodes 130. The tabs 240a from the cathodes 120 may be connected through a first bus bar. The tabs 240b from the anodes 130 may be connected through a second bus bar.

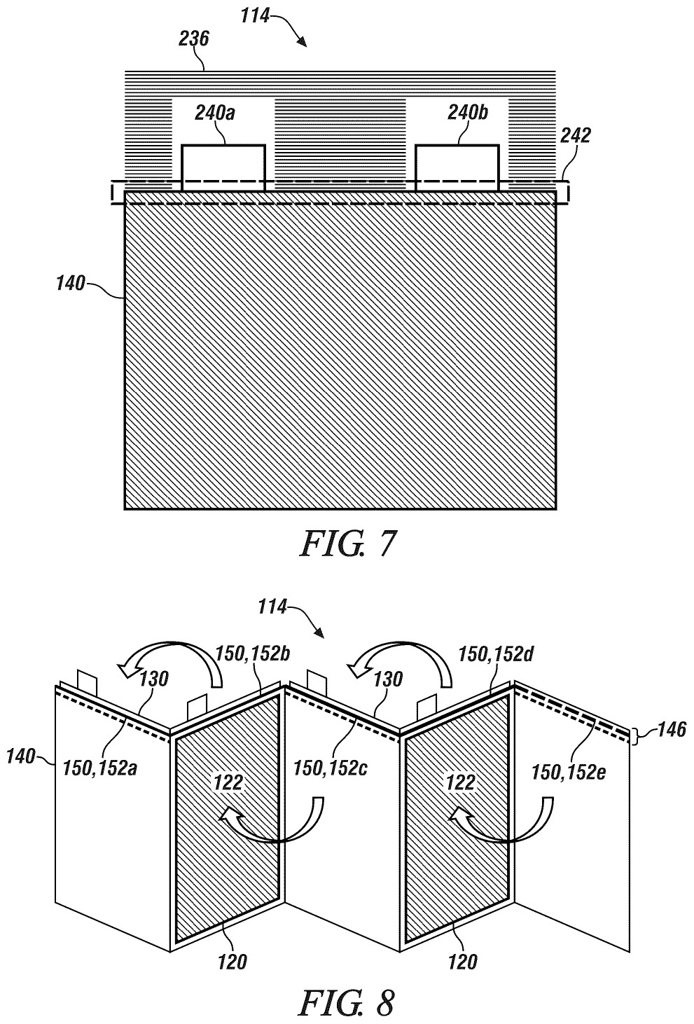

Referring to FIG. 7 with references back to FIG. 5, another schematic side view diagram of the example electrode assembly 114 is shown in accordance with one or more exemplary embodiments. A mechanical force 236 (e.g., first force 232 and/or second force 234 in FIG. 5) may be applied to the separator 140 in the area for bonding 242. The mechanical force 236 generally causes the segments 152a and 152b of the adhesive strip 150 to bond to each other and the current collector 180.

Referring to FIG. 8, a schematic perspective diagram of an example unfolded electrode assembly 114 is shown in accordance with one or more exemplary embodiments. The electrode assembly 114 illustrates multiple (e.g., two) cathodes 120 and multiple (e.g., two) anodes 130 connected with the separator 140. The cathodes 120 occupy the cathode area 122. The anodes 130 occupy the anode area 132. The separator 140 includes a bonding area 146 on the cathode-facing side 142. The cathode-facing side 142 is opposite the anode-facing side 144. The bonding area 146 may be completely outside the cathode area 122. A bonding area width of the bonding area 146 in the separator 140 may be less than approximately 2 millimeters.

The adhesive strip 150 is attached to the separator 140 in the bonding area 146. The adhesive strip 150 may be divided into the segments 152a-152e, two neighboring segments 152a-152e are associated with each cathode 120. While the separator 140 is folded and the segments 152a-152e are bonded, the segment 152e may be attached to the segment 152d, the segment 152c may be attached to the segment 152b, and so on. In various embodiments, the segments 152a-152e may be continuous (e.g., as illustrated by segment 152a) or dotted (e.g., as illustrated by segment 152e). Where dotted (or discontinuous) segments 152a-152e are bonded together, the cathode 120 may be considered partially enclosed.

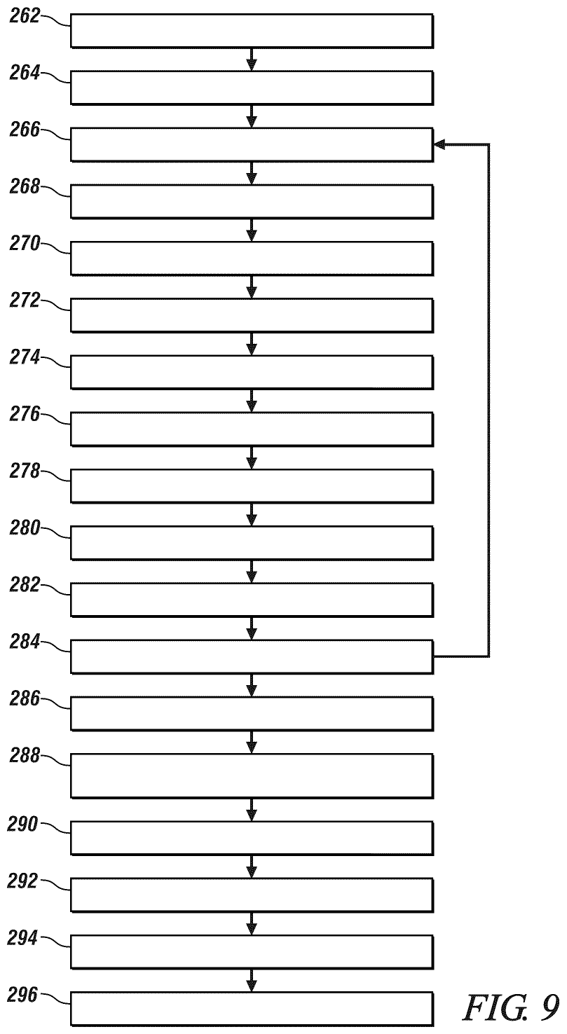

Referring to FIG. 9, a flow diagram of an example method 260 for manufacturing a secondary prismatic battery cell 100 is shown in accordance with one or more exemplary embodiments. The method 260 may be performed using existing battery cell manufacturing equipment. The method (or process) 260 includes steps 262 to xxx, as illustrated. The sequence of steps is shown as a representative example. Other step orders may be implemented to meet the criteria of a particular application.

In the step 262, the adhesive strip 150 is applied to the separator 140. The separator 140 is placed on a base plate in the step 264. An anode 130 may be placed in the step 266 on the separator 140.

In the step 268, the separator is folder over the anode 130. A cathode is placed on the separator 140 opposite the anode 130 in the step 270. The separator 140 is folded over the cathode 120 in the step 272. A force is applied to the separator 140 in the bonding area 146 in the step 274 to bond two segments 152 of the adhesive strip 150 on opposite sides of the cathode 120 to each other.

In the step 276, another anode may be placed on the separator 140 opposite the cathode 120 already present. The separator 140 is folded again in the step 278 to cover over the just-placed anode 130. In the step 280, another cathode 120 is placed on the separator 140 opposite the recently-placed anode 130. Another force is applied to the separator 140 in the bonding area 146 to bond two additional segments 152 of the adhesive strip 150 on opposite sides of the cathode 120 to each other in the step 282.

In the step 284, if additional cathodes 120 and anodes 130 are to be included, the steps 266 to 282 may be repeated. The cathodes 120 and the anodes 130 may be wrapped with the separator 140 to form an electrode assembly 114 in the step 286. The electrode assembly is disposed (or placed) in a battery cell enclosure 110 in the step 288.

In the step 290, the tabs are connected to the bus bars. The bus bars are connected to the electrical terminals 112a-112b in the step 292. An electrolyte 160 is dispose into the battery cell enclosure 110 in the step 294. The battery cell enclosure 110 may be sealed in the step 296 to complete the manufacturing of the secondary prismatic battery cell 100.

A prismatic cell design study was conducted to determine cell attributes for various example embodiments (e.g., examples 1-4) relative to control cell designs. The attributes are the same for each example and a corresponding control cell design, except for the fresh energy attribute, the cathode dimensions, and the anode dimensions. The secondary battery cell dimensions are approximately 260 mm length×103 mm height×30.9 mm width. The attributes are provided in Table I as follows:

TABLE I

| Attribute | Example 1 | Example 2 | Example 3 | Example 4 |
|---|---|---|---|---|
| Fresh Energy (Wh) | 560 | 560 | 560 | 560 |
| Control Fresh Energy | 556.91 | 556.91 | 556.91 | 556.91 |
| Nominal Voltage (V) | 3.68 | 3.64 | 3.64 | 3.64 |
| Specific Discharge | 217.0 | 225.7 | 225.7 | 225.7 |
| Capacity (mAh/g) | | | | |
| Specific Capacity (mAh/g) | 360.1 | 420.4 | 420.4 | 420.4 |
| Active Material %(+)/(−) | 97.55/97.44 | 97/95.2 | 97/95.2 | 97/95.2 |
| Areal Specific Capacity | 5.461 | 5.442 | 5.414 | 5.002 |
| (mAh/cm²) | | | | |
| N/P | 1.065 | 1.08 | 1.08 | 1.08 |
| Current Collector (+)/(−) | 12/8 | 12/8 | 12/8 | 12/8 |
| Cathode Dimensions | 9.1 × 25.14 | 9.18 × 25.14 | 9.1 × 25.14 | 9.1 × 25.14 |
| H × W (cm) | | | | |
| Control Cathode | 9.05 × 25.14 | 9.13 × 25.14 | 9.05 × 25.14 | 9.05 × 25.14 |
| Dimensions H × W (cm) | | | | |
| Anode Dimensions (cm) | 9.3 × 25.54 | 9.38 × 25.59 | 9.3 × 25.54 | 9.3 × 25.54 |
| Control Anode Dimensions | 9.25 × 25.54 | 9.33 × 25.59 | 9.25 × 25.54 | 9.25 × 25.54 |
| H × W (cm) | | | | |
| Separator Thickness (mm) | 13 | 13 | 13 | 13 |
| Separator Height | 9.5 | 9.58 | 9.5 | 9.5 |
| No. of Cathodes | 64 | 73 | 74 | 80 |

The cathode active material (CAM) composition for the various example embodiments and associated control cell designs in the study were:
Example 1: LiNi₈₉Co₆Mn₅O₂
Example 2: LiNi_{86.6}Co₅Mn_{6.6}Al_{1.8}O₂
Example 3: LiNi_{86.6}Co₅Mn_{6.6}Al_{1.8}O₂
Example 4: LiNi_{86.6}Co₅Mn_{6.6}Al_{1.8}O₂

Per the cathode dimensions in Table I, a ratio between the cathode height (e.g., 91 mm) and the enclosure height dimension (e.g., 103 mm) is greater than 0.874 to 1.

In various embodiments, the roll of the cathodes 120 and the anodes 130 may be reversed. For example, the adhesive strip 150 may be attached in the bonding area solely to the anode-facing side of the separator 140.

Embodiments of the disclosure generally provide a technique to achieve a high energy secondary Lithium-ion battery cell by maximizing an electrode dimension without increasing cell resistance. The maximized electrode dimension may be achieved by having a minimum separator overhang using an application of an adhesive and subsequent bonding step during the electrode assembly process. For existing designs, a pressure or thermal activated bonding adhesion layer is applied on a whole surface of the separator to improve the robustness of the electrode assembly process, but the resulting adhesive-coated separator has a more ionic movement resistance when compared with a pristine separator. In various embodiments, the adhesive is applied in a location limited to the separator overhang location, so the design and manufacturing method may deliver robustness of the electrode assembly process with an increased energy density without increasing the resistance of the battery cell. In particular, the resistance may be lower than existing cell designs. The adhesive is applied on the overhang area of the separator during electrode stacking process while the separator is pulled from a separator roll in the electrode assembly equipment.

By increasing the electrode size, higher volumetric energy densities may be achieved. The increased electrode (e.g., cathode) size may reduce the number of electrodes. By reducing the separator overhang using separator bonding, a volumetric energy density may be increased from approximately 673 watt hour per liter (Wh/L) to 677 Wh/L and energy content may also increase from 556.9 watt hours (Wh) to 560 Wh.

The gravimetric energy density of the cell generally increases from 283.16 watt hours per kilogram (Wh/kg) to 283.45 Wh/kg. The increased energy (Wh) and volumetric energy density (Wh/L) of the cell generally improves the vehicle mileage and may help in reducing the battery pack size.

Numerical values of parameters (e.g., of quantities or conditions) in this specification, including the appended claims, are to be understood as being modified in each instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of values and further divided ranges within the entire range. Each value within a range and the endpoints of a range are hereby disclosed as a separate embodiment.

While the best modes for carrying out the disclosure have been described in detail, those familiar with the art to which this disclosure relates will recognize various alternative designs and embodiments for practicing the disclosure within the scope of the appended claims.

What is claimed is:

1. A secondary battery cell comprising:
a battery cell enclosure;
an electrolyte disposed in the battery cell enclosure; and
an electrode assembly disposed in the battery cell enclosure, wherein the electrode assembly includes:
a cathode with a cathode area;
an anode;
a separator (i) with an anode-facing side and a cathode-facing side, (ii) with a bonding area on the cathode-facing side and completely outside the cathode area, and (iii) configured to physically separate the cathode and the anode; and
an adhesive strip applied solely on the cathode-facing side of the separator, wherein:
the cathode is either partially enclosed or completely enclosed by the separator;
the adhesive strip resides completely in the bonding area; and
two segments of the adhesive strip on opposing sides of the cathode are bonded to each other.

2. The secondary battery cell according to claim 1, wherein:
the separator is in direct physical contact with the anode and the cathode.

3. The secondary battery cell according to claim 1, wherein:
the battery cell enclosure is a prismatic metal enclosure;
a pair of electrical terminals are attached in a common plane along a side of the prismatic metal enclosure;
the pair of electrical terminals have a terminal height;
an enclosure height of the prismatic metal enclosure is between approximately 100 millimeters and approximately 110 millimeters, excluding the terminal height of the pair of electrical terminals; and
an enclosure width of the prismatic metal enclosure is between approximately 250 millimeters and approximately 300 millimeters.

4. The secondary battery cell according to claim 3, wherein:
a ratio between a cathode height of the cathode and the enclosure height of the prismatic metal enclosure is greater than 0.874 to 1.

5. The secondary battery cell according to claim 4, wherein:
the cathode, the anode, and the separator are arranged in a Z-folded stack; and
a plurality of tabs are (i) connected to the cathode and the anode and (ii) arranged in a plane parallel with a location of the pair of electrical terminals.

6. The secondary battery cell according to claim 5, wherein:
the secondary battery cell has a nominal voltage between approximately 3.63 volts and approximately 3.66 volts while energy is measured between a maximum voltage and a minim voltage of the secondary battery cell;
the cathode has an aerial specific capacity loading between approximately 4.95 milliampere hours per centimeter squared and approximately 5.4 milliampere hours per centimeter squared;
a specific capacity of cathode active material in the cathode has at least approximately 195 milliampere hours per gram when measured at a 1/10 Celsius rate at 25 degrees Celsius;
a current collector thickness of the cathode is between approximately 10 micrometers and approximately 14 micrometers;
an anode active material of the anode includes graphite and silicon oxide; and
the silicon oxide in the anode is less than 6 percent in weight ratio.

7. The secondary battery cell according to claim 6, wherein:
the cathode and the anode contain a plurality of carbon nano tubes; and
the plurality of carbon nano tubes do not exceed at least one of (i) 0.2 percent weight for the anode and (ii) 1.2 percent weight for the cathode.

8. The secondary battery cell according to claim 5, wherein:
the secondary battery cell has a nominal voltage between approximately 3.67 volts to approximately 3.71 volts while energy is measured between a maximum voltage and a minimum voltage of the secondary battery cell;
a cathode has an aerial specific capacity loading between approximately 4.95 milliampere hours per centimeter squared and approximately 5.4 milliampere hours per centimeter squared;
a specific capacity of a cathode material in the cathode has at least approximately 195 milliampere hours per gram when measured at 1/10 Celsius rate at 25 degrees Celsius; and
an anode active material of the anode is graphite.

9. The secondary battery cell according to claim 8, wherein:
the electrode assembly contains between at least 70 sheets and a maximum of 85 sheets of the cathode.

10. The secondary battery cell according to claim 1, wherein:
a bonding area width of the bonding area in the separator is less than approximately 2 millimeters.

11. A method for manufacturing a secondary battery cell comprising:
applying an adhesive strip solely on a cathode-facing side of a separator, wherein:
the separator (i) has an anode-facing side and the cathode-facing side, (ii) has a bonding area on the cathode-facing side that is completely outside a cathode area of a plurality of cathodes, and (iii) is configured to physically separate the plurality of cathodes and a plurality of anodes;
the plurality of cathodes is either partially enclosed or completely enclosed by the separator; and
the adhesive strip resides completely in the bonding area;
placing the separator on a base plate;
placing a first anode of the plurality of anodes on the separator;
folding the separator over the first anode;
placing a first cathode of the plurality of cathodes on the separator opposite the first anode;
folding the separator over the first cathode;
applying a force to the separator in the bonding area to bond two segments of the adhesive strip on opposite sides of the first cathode to each other;
placing a second anode of the plurality of anodes on the separator opposite the first cathode;
folding the separator over the second anode;
placing a second cathode of the plurality of cathodes on the separator opposite the second anode;
applying the force to the separator in the bonding area to bond two additional segments of the adhesive strip on opposite sides of the second cathode to each other;
wrapping the plurality of cathodes and the plurality of anodes with the separator to form an electrode assembly;
disposing the electrode assembly in a battery cell enclosure; and
disposing an electrolyte in the battery cell enclosure.

12. The method according to claim 11, wherein:
the separator is in direct physical contact with the plurality of anodes and the plurality of cathodes.

13. The method according to claim 11, wherein:
the plurality of cathodes, the plurality of anodes, and the separator are arranged in a Z-folded stack.

14. The method according to claim 11, wherein:
the battery cell enclosure is a prismatic metal enclosure.

15. The method according to claim 14, further comprising:
attaching a pair of electrical terminals in a common plane along a side of the prismatic metal enclosure, wherein:
the pair of electrical terminals have a terminal height.

16. The method according to claim 15, further comprising:
connecting the plurality of cathodes and the plurality of anodes to the pair of electrical terminals.

17. The method according to claim 15, wherein:
an enclosure height of the prismatic metal enclosure is between approximately 100 millimeters and approximately 110 millimeters, excluding the terminal height of the pair of electrical terminals; and
an enclosure width of the prismatic metal enclosure is between approximately 250 millimeters and approximately 300 millimeters.

18. The method according to claim 17, wherein:
a ratio between a cathode height of the plurality of cathodes and the enclosure height of the prismatic metal enclosure is greater than 0.874 to 1.

19. The method according to claim 11, wherein:
the electrode assembly contains between at least 70 sheets and a maximum of 85 sheets of the plurality of cathodes.

20. A vehicle comprising:
a battery pack with a plurality of secondary battery cells, wherein at least one of the secondary battery cells includes:
a battery cell enclosure;
an electrolyte disposed in the battery cell enclosure; and
an electrode assembly disposed in the battery cell enclosure, wherein the electrode assembly includes:
a cathode with a cathode area;
an anode;
a separator (i) with an anode-facing side and a cathode-facing side, (ii) with a bonding area on the cathode-facing side and completely outside the cathode area, and (iii) configured to physically separate the cathode and the anode; and
an adhesive strip applied solely on the cathode-facing side of the separator, wherein:
the cathode is either partially enclosed or completely enclosed by the separator;
the adhesive strip resides completely in the bonding area; and
two segments of the adhesive strip on opposite sides of the cathode are bonded to each other.
